(19) United States
(12) Patent Application Publication
(10) Pub. No.: US 2007/0186174 A1
(43) Pub. Date: Aug. 9, 2007

(54) Electronic conference system, electronic conference assistance method and conference control terminal device

(76) Inventor: Kazunori Horikiri, Tokyo (JP)

Correspondence Address: GAUTHIER & CONNORS, Suite 2300, 225 Franklin Street, Boston, MA, 02110, US

(21) Appl. No.: 11/544,392

(22) Filed: Oct. 6, 2006

(30) Foreign Application Priority Data
Feb. 7, 2006 (JP) 2006-30249

(51) Int. Cl. G06F 15/16

(52) U.S. Cl. 715/753; 709/204

(57) ABSTRACT

There is provided an electronic conference system including a conference control terminal device that is connected to a display in an electronic conference, wherein the conference control terminal device includes an image signal input unit that inputs an image signal sent from outside, a display controller that displays the inputted image signal on the display, and a storage processing unit that writes a screen image displayed on the display, in a memory.

### BACKGROUND

1. Technical Field

The present invention generally relates to an electronic conference system, and more particular to handling of an image signal inputted from outside.

2. Related Art

As a conventional electronic conference system, there is a system in which all conference participants in a conference room stay in sight of one another, and which has a touch panel display device like an electronic whiteboard installed at a position at which a display surface is touchable by a conference participant and the like. When an electronic conference is in progress, a conference presenter displays images such as conference materials and the like on this touch panel display device, and also a conference participant writes on the touch panel display device. A display control on the touch panel display device is performed by a conference control terminal device which is connected to the touch panel display device and has a dedicated application installed. The conference control terminal device captures electronic data previously prepared by a conference presenter, via a network from a document management server or an external memory device which is connected externally and possessed by the conference presenter and the like, and displays the electronic data on the touch panel display device, according to an input instruction and the like by the presenter. With respect to image data which is managed in the electronic conference system and displayed on the touch panel display device, the conference participant can write into a displayed screen image by using a note editing function prepared by the electronic conference system, and the electronic conference system can store the screen image in which a note and the like have been written, as it is.

In the conference control terminal device which can be realized with a hardware configuration of a general personal computer (PC), a terminal is provided which inputs a signal from an external device, such as an RGB signal input terminal and the like. Therefore, by connecting the PC brought by the presenter with a conference terminal device, it is possible to display the screen image displayed on a display of the PC, directly onto the touch panel display device. In this way, if the above described conventional electronic conference system is used, it is possible for all of the conference participants to share the image data captured from various information sources by displaying the image data on the touch panel display device.

### SUMMARY

According to an aspect of the invention, there is provided an electronic conference system including a conference control terminal device that is connected to a display in an electronic conference, wherein the conference control terminal device includes an image signal input unit that inputs an image signal sent from outside, a display controller that displays the inputted image signal on the display, and a storage processing unit that writes a screen image displayed on the display, in a memory.

### BRIEF DESCRIPTION OF THE DRAWINGS

Embodiments of the present invention will be described in detail based on the following figures, wherein:

FIG. 1 is a block configuration diagram showing an exemplary embodiment of an electronic conference system according to the present invention;

FIG. 2 is a block configuration diagram showing another exemplary embodiment of the electronic conference system according to the present invention; and

FIG. 3 is a flow chart showing an automatic storage process in this exemplary embodiment.

### DETAILED DESCRIPTION

Exemplary embodiments of the present invention will be described below based on the drawings.

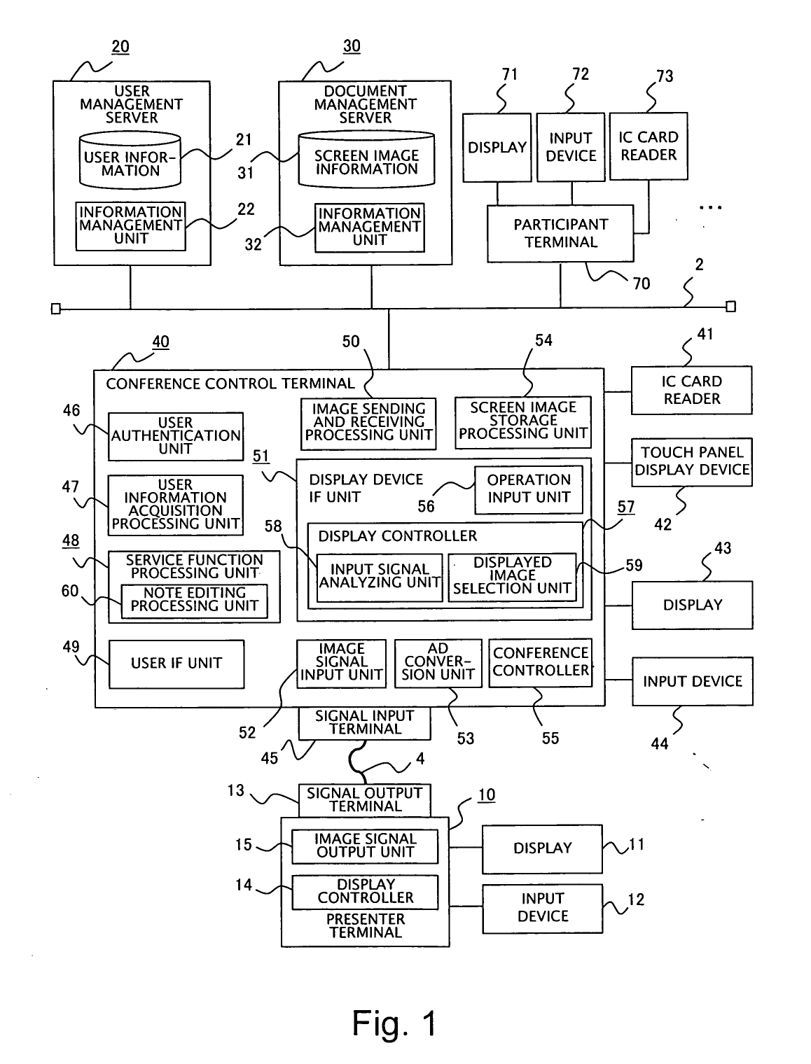

FIG. 1 is a block configuration diagram showing an exemplary embodiment of an electronic conference system according to the present invention. FIG. 1 shows an information terminal device (hereinafter referred to as “presenter terminal”) 10 used by a presenter in an electronic conference, plural information terminal devices (hereinafter referred to as “participant terminals”) 70 used individually by participants in the electronic conference, a user management server 20 which retains and manages information on users participating in the electronic conference, a document management server 30 which retains and manages screen images such as an electronic document and the like which have been prepared by the presenter or are newly created during the conference, and an information terminal device (hereinafter referred to as “conference control terminal”) 40 which performs general control of the electronic conference. The user management server 20, the document management server 30, the participant terminals 70 and the conference control terminal 40 are realized by various computers which configure the electronic conference system, and connected respectively by a LAN 2 which is one form of network. Moreover, at least the presenter terminal 10 and the conference control terminal 40 exist in a conference room. The presenter terminal 10 in this exemplary embodiment is assumed to be a PC which is brought and owned privately by the presenter in the electronic conference.

The presenter terminal 10 is assumed to be the PC as described above, and has at least a display 11, an input device 12 such as a mouse, a keyboard and the like, and an image signal output terminal 13 which is further connectable to an external device, as a hardware configuration. Moreover, the presenter terminal 10 has a display controller 14 of the display 11, and an image signal output unit 15 which outputs an image signal of display contents on the display 11 from the image signal output terminal 13. Processing functions in the display controller 14 and the image signal output unit 15 are realized with a collaborative operation of the computer constructing the participant terminal 10 and software which operates with a CPU mounted on the computer. It should be noted that the display controller 14 and the image signal output unit 15 included in the presenter terminal 10 of this exemplary embodiment may be realized with standard functions of the PC.

The participant terminal 70 is assumed to be the PC, and has at least a display 71, an input device 72 such as the mouse, the keyboard and the like, and an IC card reader 73 as a hardware configuration. Moreover, the participant terminal 70 is loaded with an electronic conference assistance program for the participant terminal, for example, for displaying the screen image displayed on a touch panel display device 42, directly on the display 71, and the like.

The document management server 30 is a server computer that stores an electronic document owned by each user participating in the electronic conference. A screen image memory 31 in the document management server 30 classifies and stores the screen image such as the electronic document and the like of each user, for each user. An information management unit 32 performs management of information retained and managed in the screen image memory 31, such as reading the screen image from the screen image memory 31, registering the screen image in the screen image memory 31 and the like, in response to requests from the conference control terminal 40.

The user management server 20 is a server computer that retains and manages the information on each user participating in the electronic conference. A user information memory 21 in the user management server 20 stores information required for a user authentication, a storage location of a screen image owned by each user, and the like. An information management unit 22 performs reading of the user information from the user information memory 21, updating the user information, and further managing and processing the information on the user such as the user authentication and the like, in response to the requests from the conference control terminal 40.

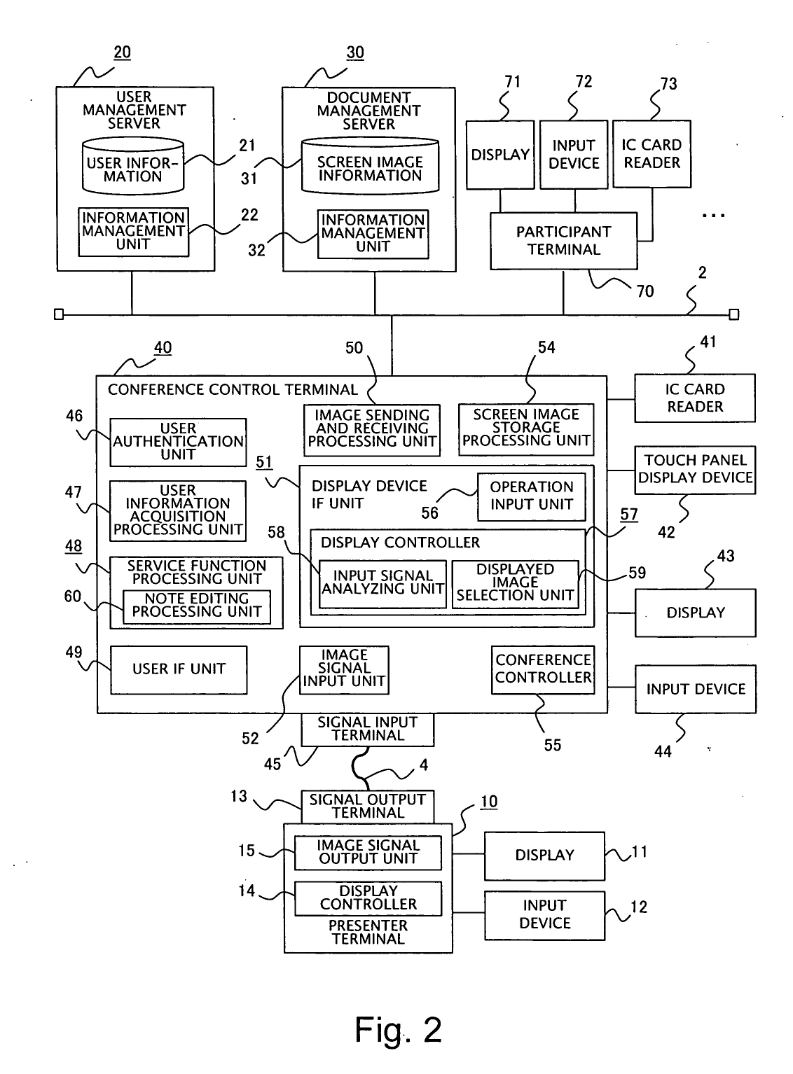

Next, the conference control terminal 40, which has a characteristic configuration in this exemplary embodiment, has at least an IC card reader 41, the touch panel display device 42, a display 43, an input device 44 such as the mouse, the keyboard and the like, and a signal input terminal 45 which is further connectable to the external device, as a hardware configuration. Moreover, the conference control terminal 40 has a user authentication unit 46, a user information acquisition processing unit 47, a service function processing unit 48, a user interface (IF) unit 49, an image sending and receiving processing unit 50, a display device interface (IF) unit 51, an image signal input unit 52, an AD conversion unit 53, a screen image storage processing unit 54 and a conference controller 55. Moreover, if a digital image is inputted or outputted through a DVI (Digital Video Interface), HDMI (High Definition Multimedia Interface) or the like, the AD conversion unit becomes unnecessary, and FIG. 2 shows a configuration diagram in this case. The user authentication unit 46 performs the user authentication with respect to the participant in the electronic conference. The user information acquisition processing unit 47 executes and controls service functions provided by the electronic conference system in this exemplary embodiment. Among these service functions, a note editing processing unit 60 performs a note editing function that allows the user to perform edit functions, such as note writing and the like, with respect to the screen image displayed on the touch panel display device 42. The user interface unit 49 controls input and output of the display 43 and the input device 44. The image sending and receiving processing unit 50 sends the screen image to and receives the screen image from the document management server 30. The screen image storage processing unit 54 stores the screen image which has become a storage target, in the document management server 30, by using the image sending and receiving processing unit 50 and also collaboratively operating with the information management unit 32 of the document management server 30. It should be noted that these exemplary embodiment sends the screen image which has become the storage target directly to the document management server 30, but the screen image which has become the storage target may be temporarily retained inside the conference control terminal 40 and then sent collectively. The image signal input unit 52 inputs the signal inputted from the signal input terminal 45. If the signal which is inputted by the image signal input unit 52 and displayed on the touch panel display device 42 is an analog signal, the AD conversion unit 53 converts the displayed signal into a digital signal. The display device interface (IF) unit 51 controls input and output of the touch panel display device 42. An operation input unit 56 inputs a user operation with respect to the touch panel display device 42, such as writing with a writing pen, touching a display surface and the like. A display controller 57 performs display control on the touch panel display device 42. An input signal analyzing unit 58 included in the display controller 57 recognizes an input operation by the presenter from the presenter terminal 10, by analyzing the image signal inputted by the image signal input unit 52, and in response to the recognized input operation, performs a previously prescribed display control with respect to the touch panel display device 42. Moreover, according to the input from the user interface unit 49 or the operation input unit 56, or according to a result of analyzing the image signal by the input signal analyzing unit 58, a displayed image selection unit 59 selects either the screen image formed based on the input from the image signal input unit 52 or the screen image captured from the document management server 30, as the screen image to be displayed on the touch panel display device 42. The conference controller 55 controls the entire electronic conference in the electronic conference system.

The processing functions in the above described respective units 46 to 55 in the conference control terminal 40 are realized with a collaborative operation of the computer constructing the conference control terminal 40 and an electronic conference assistance program which is executed by a CPU contained on the computer.

In this application, as may be understood also from the above described system configuration, the electronic conference system is not necessarily limited to a conference conducted by connecting remote locations, and collectively refers to conferences conducted by using computers, such as the conference control terminal 40 and the participant terminal 70 which configure the electronic conference system, and the presenter terminal 10 which further externally connects to the electronic conference system and the like.

Next, operations in this exemplary embodiment will be described. In the following description, first, a basic operation of the electronic conference system corresponding to general conducting of the electronic conference, specifically, description will be given of displaying on the touch panel display device 42, storage of the display contents, and the note editing function. Thereafter, the storage of the display contents and the note editing function when the image signal captured from the presenter terminal 10, which is the external device, is displayed on the touch panel display device 42 will be described. Furthermore, a method of addressing challenges which occur newly by handling the image signal captured from the presenter terminal 10 and the like will be described.

When the presenter in the conference has his own IC card read by the IC card reader 41 connected to the conference control terminal 40, the user authentication unit 46 sends a user ID of the presenter read by the IC card reader 41 to the user management server 20, and queries an attribute of the IC card owner. The information management unit 22 in the user management server 20 authenticates the user by confirming authenticity of the presenter of the conference with the sent user ID, and returns a result of the authentication to the user authentication unit 46. Moreover, the information management unit 22 updates the information on the user and the like, such as the conference which the user is attending and the like, if necessary. When the user is authenticated by the user authentication unit 46, the user information acquisition processing unit 47 acquires the user information on the presenter from the user management server 20. In this exemplary embodiment, the user information acquisition processing unit 47 may acquire at least the storage location of the screen image managed by the presenter. Specifically, the user information acquisition processing unit 47 acquires a URL for identifying the storage area (repository) in the document management server 30. As described above, the presenter is allowed to participate in the conference. The participant terminal 70 used by other conference participant also operates similarly to the conference control terminal 40 to perform the user authentication of each conference participant, and allows each conference participant to participate in the conference.

By operating the conference control terminal 40, the presenter in the electronic conference reads the image data of conference materials which has been previously registered in the document management server 30, displays the image data on the touch panel display device 42, and proceeds with the conference, appropriately updating the screen image to be displayed. In this exemplary embodiment, a style of proceeding with the conference is assumed in which the conference participants gather around the touch panel display device 42 to debate about the contents displayed on the touch panel display device 42, and if necessary, use the note editing function mounted on the conference control terminal 40 to write a note and the like on the screen image.

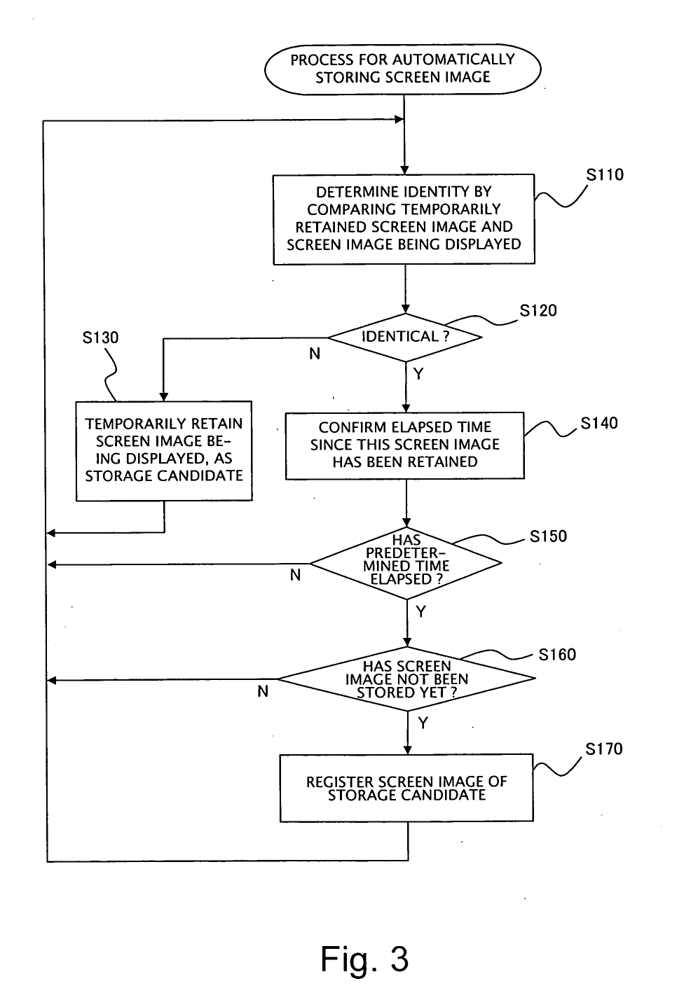

Here, a process for storing the screen image will be described. As the storage of the screen image, there are a manual storage with a user operation of depressing a note storage button which is prepared as a GUI part and displayed on the display 43 by the electronic conference system, and an automatic storage. Here, a process for automatically storing the screen image will be briefly described with a flow chart shown in FIG. 3.

The screen image storage processing unit 54 compares the screen image which has been temporarily retained as a storage candidate as described below, and the screen image displayed on the touch panel display device 42, and determines an identity between these screen images (step 110). Detailed contents of this process for determining the identity will be described below. Here, if it is determined that these screen images are not identical (N at step 120), the screen image being displayed is temporarily retained as the storage candidate (step 130). For example, this corresponds to the case where the conference participant is in the middle of writing the note on the touch panel display device 42 and the case where it is immediately after the display of the conference materials has been switched.

On the other hand, if it is determined that these screen images are identical (Y at step 120), it may be considered that the screen image displayed on the touch panel display device 42 is maintained in this case. In this case, an elapsed time since the screen image was temporarily retained is confirmed (step 140). Here, if the screen image has been retained for a preset predetermined time, in other words, if it is determined that an identical screen image has continued to be displayed on the touch panel display device 42 for the predetermined time (Y at step 150), and if the screen image has not been stored (Y at step 160), the screen image storage processing unit 54 sends the screen image to the document management server 30 and registers the screen image therein (step 170). It should be noted that if the predetermined time has not elapsed at step 150, the storage of the screen image is maintained. This corresponds to, for example, a state in which there is no pen input temporarily in the middle of writing the note into the screen image. Moreover, if the screen image has already been stored at step 160, since it is not necessary to store the identical screen image again, the screen image is also not stored in this case.

For example, if the above described predetermined time is set to five seconds, when a screen display on the touch panel display device 42 has been maintained for five seconds, the screen image storage processing unit 54 stores the screen image. On the other hand, if the screen display on the touch panel display device 42 has been changed, or if the screen display on the touch panel display device 42 has not been changed but five seconds have not elapsed since the screen image has been displayed, the screen image is not stored.

Subsequently, the note editing function provided by this exemplary embodiment will be described. When the conference participant ejects the writing pen from a predetermined stored position for the note writing, the note editing processing unit 60 is activated. The note editing processing unit 60 locks the display so that the screen image which is a target of the note editing may not be updated immediately after the activation. The conference participant then writes the note into the screen image in a still image state. As termination of the note editing function, there are manual storage with a user operation of depressing a note editing termination button which is prepared as a GUI part and displayed on the display 43 by the electronic conference system, and automatic storage by using the above described function of automatically storing the screen image. In the case of automatically storing the screen image, when the note has not been written for the predetermined time during using the note editing function, it is determined that the conference participant has quit the note writing, in other words, the conference participant has decided to terminate using the note editing function, and the screen image in which the note has been written is stored automatically at the same time as execution of the note editing function is terminated.

Next, the storage of the screen image displayed based on an external input and the like, which is a characteristic of this exemplary embodiment, will be described.

Although typically the presenter has converted the materials to be used in the conference into electronic data and previously registered the electronic data in the document management server 30 as described above, there may be a case where the presenter hopes to use the materials stored only in the privately owned PC (presenter terminal 10) brought into the conference room by the presenter, depending on contents of the conference. In such a case, it is possible to display the materials stored only in the presenter terminal 10, on the touch panel display device 42, by connecting the presenter terminal 10 to the conference control terminal 40. However, in the related art, it has not been possible to store the displayed screen image. Consequently, in this exemplary embodiment, the display contents which have been captured from the presenter terminal 10 and displayed on the touch panel display device 42 are stored as follows.

First, the presenter connects the presenter terminal 10 to the conference control terminal 40 with a connecting cable 4. Then, any conference participant depresses an “External inputted screen capture” button displayed on the display 43. When the depressing of this button is detected, the displayed image selection unit 59 of the display controller 57 switches a source of the image data to be displayed on the touch panel display device 42, from the document management server 30 to the signal input terminal 45. As a result, the display controller 57 performs the screen display with respect to the touch panel display device 42, based on the image signal inputted by the image signal input unit 52. It should be noted that if the inputted image signal is the analog signal such as the RGB signal, the inputted analog signal is converted into the digital signal by the AD conversion unit 53 and then displayed on the touch panel display device 42. In this way, the screen image displayed on the display 11 of the presenter terminal 10 is displayed directly on the touch panel display device 42, and the screen image storage processing unit 54 stores the screen image displayed on the touch panel display device 42 in a storage area corresponding to the presenter in the document management server 30, using the above described process for automatically storing the screen image.

Incidentally, when the note editing is performed, in the electronic conference system in this exemplary embodiment, if the writing pen is ejected from the predetermined stored position, the display on the touch panel display device 42 is locked. This locked state is released for the first time when the note editing is terminated, or when there has been an operation with respect to the touch panel display device 42, specifically an action of touching the display surface of the touch panel display device 42.

Here, it is assumed that the presenter terminal 10 can be installed only at a position separated from the touch panel display device 42, due to a position at which the connector to the conference control terminal 40 is installed in the conference room. That is, it is assumed that the presenter sits at a position separated from the touch panel display device 42, in order to display the display contents of the presenter terminal 10 on the touch panel display device 42. In such a condition, it is assumed that anyone other than the presenter has ejected the writing pen from the predetermined stored position. As a result, the display on the touch panel display device 42 becomes locked. Here, it is assumed that the presenter hopes to change the display contents with respect to the touch panel display device 42. At this time, since the touch panel display device 42 has been locked, the lock of the display on the touch panel display device 42 has to be released in order to change the display contents. However, since the presenter sits in the position separated from the touch panel display device 42, the presenter has to terminate the note editing function, or move to the touch panel display device 42 to touch the display surface, in order to release the lock of the display. In the note editing function, there is no problem in an automatic termination mode, but if not that mode, it is not possible to release the lock of the display. In the related art, the lock of the display is released by requesting the conference participant who is positioned near the display 43 to depress a note editing termination button, or requesting the conference participant who is positioned near the touch panel display device 42 to touch the display surface, and it has not been possible for the presenter himself to release the lock of the display. Consequently, in this exemplary embodiment, it is possible to release the lock of the display by operating the presenter terminal 10. Hereinafter this method of releasing the lock of the display will be described.

In order to release the lock of the display on the touch panel display device 42 from the presenter terminal 10, it is necessary to have previously defined an operation corresponding to a lock release instruction. For example, the lock release instruction has been defined as an operation of drawing a circle with a mouse cursor around the lower right corner on the display 11.

While the display contents of the presenter terminal 10 are displayed on the touch panel display device 42, the input signal analyzing unit 58 of the display controller 57 constantly analyzes the inputted image signal, detects the input operation by the presenter, that is, a display position of the mouse cursor in this example, and recognizes a moving state of the mouse cursor. If the input signal analyzing unit 58 recognizes that the mouser cursor is moving in such a way as to draw the circle around the lower right corner within a display screen, the input signal analyzing unit 58 recognizes this user operation of moving the mouse cursor as the lock release instruction, and releases the lock of the display on the touch panel display device 42. As a result, the display controller 57 displays the contents being displayed on the display 11 of the presenter terminal 10 at a point in time of where the lock is released, on the touch panel display device 42.

It should be noted that in the above description, although an example of the lock release instruction is the operation of moving the mouse cursor for drawing the circle around the lower right corner within the display screen, the release of the lock of the display is not limited to this user operation. Moreover, in this exemplary embodiment, although, in order to address the challenges which occur newly, the release of the lock of the display has been described as the display control with respect to the touch panel display device 42, it is possible to use so that the display control with respect to the touch panel display device 42 may be performed with other user operations. For example, a horizontal movement of the mouse cursor is set as a blank sheet display instruction, and the like.

Finally, the determination of the identity of the screen image will be described. In the respective processes of the function of automatically storing the screen image and the note editing function in the conference control terminal 40, it has been described that the currently displayed screen image and the temporarily retained screen image are compared, and if it can be confirmed that the identical screen image has continued to be displayed for the predetermined time, the screen image is stored.

In actual fact, however, it may be incorrectly recognized that the screen image is not perfectly identical, that is, the screen image has continued to be updated in the same way as during the note writing, in the comparison process in the screen image storage processing unit 54, due to signal noise which has occurred while transferring the screen image and the like. In this way, when the signal noise has been mixed with the screen image due to degradation in communication quality and the like, even if the identical screen image has been displayed, it may be incorrectly recognized that the screen image has been changed frequently (before the predetermined time period (5 seconds in the above described example) has elapsed), and as a result, it may also become impossible to store even a single presenter screen during the conference.

Consequently, in this exemplary embodiment, an allowable range for determining as identical is set when comparing the screen images.

For example, a value of one pixel included in the screen image being displayed is set as P, and a value of a corresponding pixel in the temporarily retained screen image is set as C. A count of becoming P≠C is accumulated, and if its percentage does not exceed a certain number or a certain ratio with respect to a number of pixels in the entire screen image, the compared screen images are regarded as identical.

Moreover, if there is a case where the screen image is inputted as the analog signal, a process for comparing the pixels and a filtering process are considered as methods of determining the identity. In the former case, when the value of one pixel in the screen image being displayed is set as P, the value of the corresponding pixel in the temporarily retained screen image is set as C, and a noise margin is set as N, if |P−C|<N is satisfied, these pixels are regarded as having the same value. In the latter case, images which can be acquired by applying a digital noise filter (for example, using DCT (Discrete Cosine Transform) to cut a high spatial frequency domain and the like) with respect to the inputted image signals, are compared. For example, when a filter function is set as f, the identity between the screen images is determined by whether or not |f(P)−f(C)|<N is satisfied.

It should be noted that, with respect to thresholds (criterion values) which are set for determining whether or not the screen images are identical, such as the certain number, the certain ratio, the noise margin and the like as described above, it is considered that the criterion values can be set to relatively moderate values, considering that the screen image to be determined as not identical in the electronic conference system is the screen image which is displayed when the display contents are switched or in the middle of the note writing and the like.

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An electronic conference system, comprising:
a conference control terminal device that is connected to a display in an electronic conference,
wherein the conference control terminal device comprises:
an image signal input unit that inputs an image signal sent from outside;
a display controller that displays the inputted image signal on the display; and
a storage processing unit that writes a screen image displayed on the display, in a memory.

2. A computer readable medium storing a program causing a computer that is connected to a display in an electronic conference to execute a process for assisting the electronic conference, the process comprising:
inputting an image signal sent from outside;
displaying the inputted image signal on the display; and
writing a screen image displayed on the display to a memory.

3. The computer readable medium according to claim 2, the process further comprising:
when an image signal forming a screen image which is different from the screen image being displayed on the display has not been inputted within a predetermined time, writing the screen image being displayed to the memory.

4. The computer readable medium according to claim 2, the process further comprising:
if the screen image is being displayed on the display based on the image signal inputted from a presenter terminal device used by a presenter, performing a display control with respect to the display in response to an input operation by the presenter.

5. The computer readable medium according to claim 4, the process further comprising:
in response to the input operation, releasing displaying of the screen image which has been displayed in a fixed state on the display.

6. A conference control terminal device, comprising:
an image signal input unit that inputs an image signal sent from outside;
a display controller that displays the inputted image signal on a display connected to the conference control terminal device; and
a storage processing unit that writes a screen image displayed on the display to a memory.

7. The conference control terminal device according to claim 6, wherein:
when an image signal forming a screen image which is different from the screen image being displayed on the display has not been inputted within a predetermined time, the storage processing unit writes the screen image being displayed to the memory.

8. The conference control terminal device according to claim 6, wherein:
if the screen image is being displayed on the display based on the image signal inputted from a presenter terminal device used by a presenter, the display controller performs a display control with respect to the display in response to an input operation by the presenter.

9. The conference control terminal device according to claim 8, wherein:
in response to the input operation, the display controller releases displaying of the screen image which has been displayed in a fixed state on the display.

10. An electronic conference assistance method performed by a computer that configures an electronic conference system having a conference control terminal device that is connected to a display in an electronic conference, comprising:
inputting an image signal sent from outside;
displaying the inputted image signal on the display; and
writing a screen image displayed on the display to a memory.

11. A computer data signal embodied in a carrier wave for enabling a computer that is connected to a display in an electronic conference to perform a process for assisting the electronic conference, the process comprising:
inputting an image signal sent from outside;
displaying the inputted image signal on the display; and
writing a screen image displayed on the display, in a memory.
